(19) United States
(12) Patent Application Publication
(10) Pub. No.: US 2007/0159760 A1
(43) Pub. Date: Jul. 12, 2007

(54) Methods and Systems Related to Pulsed Power

(76) Inventor: Collins Clark, Albuquerque, NM (US)

Correspondence Address: V. Gerald Grafe, esq., P.O. Box 2689, Corrales, NM, 87048, US

(21) Appl. No.: 11/677,295

(22) Filed: Feb. 21, 2007

Related U.S. Application Data
(63) Continuation-in-part of application No. 11/433,031, filed on May 12, 2006.
(60) Provisional application No. 60/775,292, filed on Feb. 21, 2006.
(60) Provisional application No. 60/680,674, filed on May 13, 2005.

(51) Int. Cl. H02H 9/06

(52) U.S. Cl. 361/118

(57) ABSTRACT

The present invention provides circuits and devices that allow improved performance from pulsed power systems. Some embodiments of the present invention comprise a MARX system; an inductor system in electrical communication with the MARX system; a surge arrestor system in electrical communication with the inductor system; an output switch system in electrical communication with the surge arrestor system; and a crowbar switch system in electrical communication with the output switch system. A static test load can be selectively coupled to the system for example at the output of the output switch or crowbar switch, to allow the system to be easily tested without risk to actual loads. An example static test load can include a plurality of metal oxide varistors connected in an electrical series and placed in electrical communication with the output terminal of the output switch and with the reference potential.

### CROSSREFERENCE TO RELATED APPLICATIONS

This application claims the benefit of U.S. provisional application 60/775,292, “Pulsed Power System,” tiled Feb. 21, 2006, and claims priority as a continuation in part of U.S. patent application Ser. No. 11/433,032, “Methods and Apparatuses Related to Pulsed Power,” filed May 12, 2006, which application claims the benefit of U.S. provisional application 60/680,674, “Methods and Apparatuses Related to Pulsed Power,” filed May 13, 2005. Each of the applications listed above is incorporated herein by reference.

### BACKGROUND

The present invention relates to methods and apparatuses related to pulsed power. More specifically, the present invention relates to circuits and devices suitable for use in shaping pulses in pulsed power systems, and pulsed power systems incorporating such circuits or devices.

Pulsed power is used to generate and apply energetic beams and high-power energy pulses. It is distinguished by the development of repetitive pulsed power technologies, x-ray and energetic beam sources, and electromagnetic and radiation hydrodynamic codes for a wide variety of applications. Examples of these applications include: High power Microwave beam generation; Nuclear survivability and hardness testing; Measurement of material properties; Z-pinch-driven inertial confinement fusion. Materials processing; Waste and product sterilization and food purification; Electromagnetically-powered transportation; and interpreting data from x-ray binaries and galactic nuclei.

Pulsed power applications such as these place extraordinary demands on the devices used for power production. In particular, the requirements for pulse width range from nanoseconds to many milliseconds, the currents from amperes to many kiloamperes and the voltages from a few kilovolts to well in excess of one million volts. Using prior art, it is necessary to employ a number of unique pulsed power driver solutions to span this large parameter range. Each solution requires individual development and implementation which must be repeated for each separate application. It is often desirable to combine the best features of each technique into an optimized solution for existing or new applications but this is not possible with the prior art. Therefore there is a need for circuits and devices that are capable of combining the best features of each into a single concept such as that exhibited by the characteristics of this invention. In particular, there is a need for improvements in pulsed power systems that can provide simple, easy adjustment of operating parameters such as pulse width and output current.

### SUMMARY OF THE INVENTION

The present invention provides circuits and devices that allow improved performance from pulsed power systems. Some embodiments of the present invention comprise a MARX system; an inductor system in electrical communication with the MARX system; a surge arrestor system in electrical communication with the inductor system; an output switch system in electrical communication with the surge arrestor system; and a crowbar switch system in electrical communication with the output switch system. A static test load can be selectively coupled to the system, fir example at the output of the output switch or crowbar switch, to allow the system to be easily tested without risk to actual loads. An example static test load can include a plurality of metal oxide varistors connected in an electrical series and placed in electrical communication with the output terminal of the output switch and with the reference potential.

Some embodiments of surge arrestor systems suitable for use in the present invention comprise a plurality of surge arrestor elements, each having first and second terminals, and disposed in series, where the first surge arrestor element in the series has a first terminal adapted to be placed in electrical communication with the inductor system; the last surge arrestor element in the series has a second terminal adapted to be placed in electrical communication with the output switch system; each surge arrestor element in the series other than the last has a second terminal in electrical communication with the first terminal of the next surge arrestor element in the series; and the surge arrestor elements are mounted relative to each other such that electrical current in one surge arrestor element is in a direction substantially opposite electrical current in an adjacent surge arrestor element.

Some embodiments of surge arrestor system suitable for use in the present invention comprise a surge arrestor element having first and second ends between which current flows in operation; and a return conductor in electrical communication with the surge arrestor element proximal the first end thereof, and configured such that the return conductor effectively surrounds the surge arrestor element in directions perpendicular to the direction of current flow through the surge arrestor element in operation. The return conductor can, as examples, be spaced apart from the surge arrestor element by a first distance near the first end of the surge arrestor element, and by a second distance, greater than the first distance, near the second end of the surge arrestor element; comprise a substantially solid surface surrounding the surge arrestor element in directions perpendicular to the direction of current flow through the surge arrestor element in operation; or comprise a plurality of conductive elements disposed about the surge arrestor element such that each conductive element is separated from the surge arrestor element by respective first distance near the first end of the surge arrestor element and by a respective second distance, greater than the first distance, near the second end of the surge arrestor element. Some embodiments of surge arrestor systems suitable for use in the present invention can comprise a plurality of metal oxide varistor elements. Some embodiments also provide an external circuit terminal, mounted with the surge arrestor system such that the terminal can be placed selectively in electrical communication with the second terminal of any of several of the plurality of surge arrestor elements.

Example embodiments of the present invention can comprise an electrostatic energy storage system, having a reference terminal adapted to be placed in electrical communication with a reference potential, and having an output terminal; an inductor, having an input terminal in electrical communication with the output terminal of the electrostatic energy storage system, and having an output terminal; a surge arrestor apparatus having first and second terminals, wherein the first terminal of the surge arrestor apparatus is in electrical communication with the output terminal of the inductor, and wherein the second terminal of the surge arrestor apparatus is adapted to be placed in electrical communication with the reference potential; an output switch, having input and output terminals, wherein the input terminal is in electrical communication with the output terminal of the inductor, wherein the output switch selectively places its input and output terminals in electrical communication, and wherein the output terminal is adapted to be placed in electrical communication with a load; and a crowbar switch, having input and output terminals, wherein the input terminal is in electrical communication with either the input or output terminal of the output switch, and wherein the output terminal is in electrical communication with the reference potential, and wherein the crowbar switch selectively places its input and output terminals in electrical communication.

In some embodiments, the electrostatic energy storage system can include a plurality of capacitors, each having nonconductive mounting features adapted to allow secure and removable mounting with a support structure. In some embodiments, the electrostatic energy storage system can include a plurality of MARX capacitors; a plurality of switch electrodes, each mounted with a MARX capacitor such that electrical communication between the MARX capacitors can be accomplished through the switch electrodes; and a plurality of trigger generators, each mounted with a switch electrode; wherein each trigger generator comprises a plurality of switch/capacitor elements connected in series, wherein each switch/capacitor element comprises a solid state switch and a capacitor connected in parallel. In some embodiments, the electrostatic energy storage system can include a plurality of capacitors, mounted such that they can be connected via switches; and a fault protection element mounted between the terminals of a switch, comprising a plurality of metal oxide varistors.

Some embodiments can further provide a voltage selector element comprising a plurality of metal oxide varistors disposed in electrical series between a first terminal and a second terminal, and wherein the first terminal is in electrical communication with the output terminal of the output switch, and wherein the second terminal is in electrical communication with the reference potential, and having a third terminal in electrical communication with an intermediate point in the series-connected metal oxide varistors.

Some embodiments provide an output switch having first and second electrodes, and a trigger generator, mounted with the first electrode; wherein the trigger generator comprises a plurality of switch/capacitor elements connected in series, wherein each switch/capacitor element comprises a solid state switch and a capacitor connected in parallel. Some embodiments provide a crowbar switch having first and second electrodes, and a trigger generator, mounted with the first electrode; wherein the trigger generator comprises a plurality of switch/capacitor elements connected in series, wherein each switch/capacitor element comprises a solid state switch and a capacitor connected in parallel.

Some embodiments provide an inductor comprising first and second spiral conductors mounted in proximity to each other.

The present invention can provide for highly accurate pulse timing, which cans allow multiple pulsed power systems according to the present invention to be used together, in series or in parallel.

The advantages and features of novelty that characterize the present invention are pointed out with particularity in the claims annexed hereto and forming a part hereof. However, for a better understanding of the invention and the methods of its making and using, reference should be made to the drawings which form a further part hereof, and to the accompanying descriptive matter in which there are illustrated and described preferred embodiments of the present invention. The description below involves several specific examples; those skilled in the alt will appreciate other examples from the teachings herein, and combinations of the teachings of the examples.

### BRIEF DESCRIPTION OF THE DRAWINGS

FIG. 1 is a schematic illustration of an example circuit for a pulsed power system incorporating a surge suppressor according to the present invention.

FIG. 2 is a schematic illustration of a surge suppressor system with a return conductor.

FIG. 3 is a schematic illustration of a surge suppressor system having a plurality of surge arrestor elements in a series circuit and arranged such that current flows in opposite directions in adjacent surge arrestor elements.

FIG. 4 is a schematic illustration of a surge suppressor system having a plurality of surge arrestor elements is series and arranged along a curve in two dimensions.

FIG. 5 is a schematic illustration of a surge suppressor system having a plurality of surge arrestor elements disposed within and coaxial with a return conductor.

FIG. 6 is a graph of two dimensional electrostatic simulation results for the system depicted in FIG. 5.

FIG. 7 is a schematic illustration of a Marx generator having switches according to the present invention.

FIG. 8 is a schematic illustration of a Marx generator having switches and surge suppressor systems according to the present invention.

FIG. 9 is a schematic illustration of the addition of a surge suppression system according to the present invention added to a conventional Marx generator system.

FIG. 10 is a schematic illustration of the application of a surge suppression system according to the present invention applied to driving a high power microwave load.

FIG. 11 is a schematic illustration of a surge suppression system according to the present invention in application.

FIG. 12 is a schematic illustration of an example circuit for a pulsed power system incorporating a surge suppressor according to the present invention.

FIG. 13 is a schematic depiction of performance characteristics of a system such as that shown in FIG. 12.

FIG. 14 is a schematic illustration of an example embodiment of the present invention.

FIG. 15 is a schematic block diagram of a pulsed power system according to an example embodiment of the present invention.

FIG. 16 is a schematic illustration of a capacitor and support structure in accord with an example embodiment of the present invention.

FIG. 17 is a schematic illustration of switch electrodes mounted with capacitors in accord with an example embodiment of the present invention.

FIG. 18 is a schematic illustration of a switch trigger in accord with an example embodiment of the present invention,

FIG. 19 is an example electrical schematic diagram of trigger generators in a MARX system in accord with an example embodiment of the present invention.

FIG. 20 is a schematic illustration of MOV-based switch protection in accord with an example embodiment of the present invention.

FIG. 21 is a schematic sectional view of an inductor system in accord with an example embodiment of the present invention.

FIG. 22 is a schematic illustration of an example embodiment of the present invention providing adjustable voltage.

FIG. 23 is a schematic illustration of an output switch in accord with an example embodiment of the present invention.

FIG. 24 is a schematic illustration of a crowbar switch in accord with an example embodiment of the present invention.

FIG. 25 is a schematic illustration of a static load system in accord with an example embodiment of the present invention.

### DESCRIPTION OF THE INVENTION

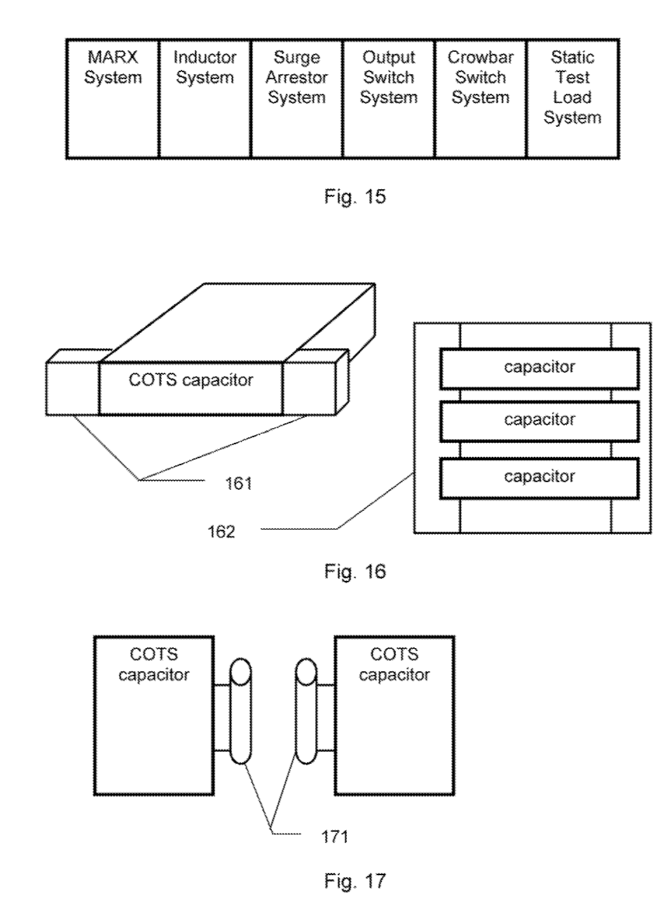

The present invention comprises a high voltage, high current system capable of delivering well-conditioned electrical pulses to advanced devices such as high power microwave generators, charged particle generators, electromagnetic radiating structures, etc. (sometimes referred to herein as an “active load”). The system is described in the context of various systems or elements; those skilled in the art will appreciate other subdivisions or combinations of features in various embodiments and implementations. FIG. 15 is a schematic block diagram of a pulsed power system according to an example embodiment of the present invention. The system comprises an electrostatic energy storage system (e.g., a MARX system); an inductor system, a surge arrestor apparatus; an output switch, and a crowbar switch. Some embodiments further comprise a static test load.

Electrostatic Energy Storage System.

The electrostatic energy storage system converts a moderate voltage to a high power pulse. MARX systems or generators are common examples of such systems. Some embodiments of the present invention include MARX generators with specific features that can provide corresponding advantages.

MARX systems can be constructed of a plurality of capacitors. FIG. 16 is a schematic illustration of a capacitor and support structure in accord with an example embodiment of the present invention. A plurality of capacitors mount, securely but also removably, with a support structure. Each individual capacitor (which can be conventional capacitors suitably modified) has support brackets 161 made of nonconductive material (e.g., plastic) mounted with it. These brackets allow each capacitor to be inserted in a slotted support structure 162 and bolted rigidly in place using plastic connectors. Since support can be provided on three out of the four horizontal edges of the capacitor, the assembly can be rotated into any orientation without flexing or displacing the capacitors. In addition, maintenance or replacement of any individual capacitor can be accomplished simply and quickly by removing the bolts and extracting the unit.

FIG. 17 is a schematic illustration of MARX system switch electrodes according to an example embodiment of the present invention. Switch electrodes 171 can be attached directly to the capacitors. The switch electrodes can comprise a cylindrical shape which spreads the switch arc thus reducing electrode erosion and increasing switch lifetime. In addition, spreading the arc has the effect of reducing arc temperature and increasing pulse repetition rate capability. In additions mounting the switch electrodes directly to the capacitor greatly reduces the size compared to prior art. In addition, maintenance of switch is greatly simplified over prior art.

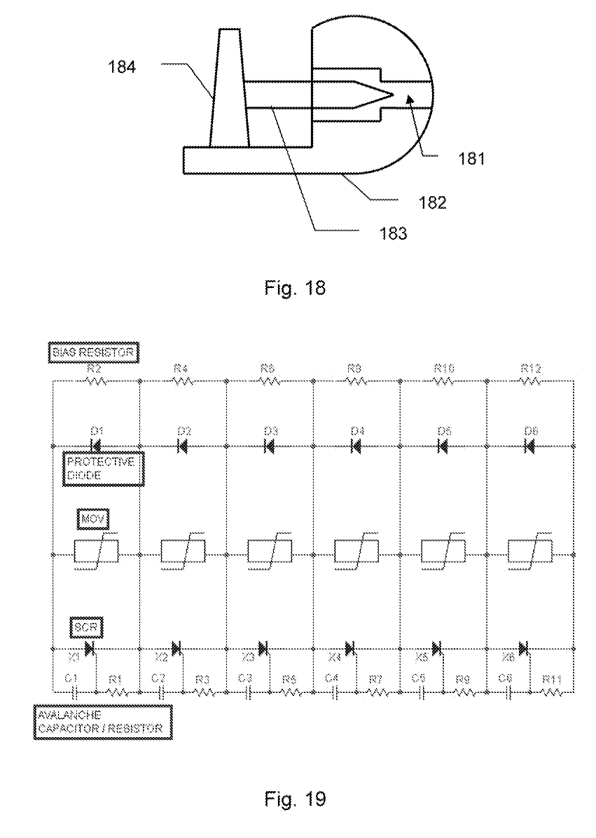

FIG. 18 is a schematic illustration of a switch trigger according to an example embodiment of the present invention. A switch electrode 182 present a roughly circular shape. An opening 181 is formed within the switch electrode 182, extending through the electrode's circular surface. A trigger pin 183 mounts with a trigger pin holder 184. Triggering of the switch can be accomplished with a set of pins 183 inserted in a set of holes 181 in the switch electrode. These pins can be recessed within the electrode structure so that they are shielded from the arc. This can reduce trigger pin erosion and increases switch lifetime. A switch trigger can be connected to the pins to introduce a plasma into the space between the electrodes, which enables the desired conduction.

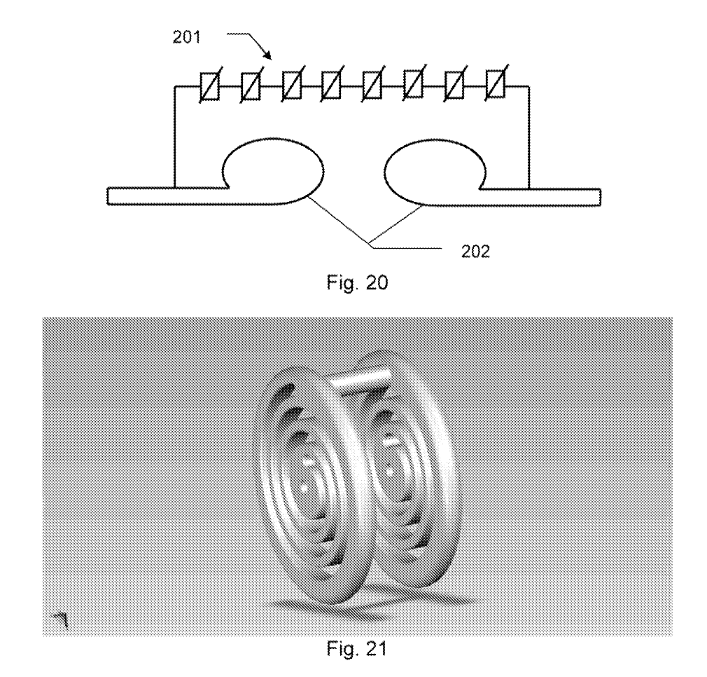

FIG. 19 is a schematic illustration of trigger generators according to an example embodiment of the present invention. The trigger generators in the example are based on MOV technology. It can be constructed of commercial, off-the-shelf (“COTS”) components arranged in a new circuit which provides high voltage, fast risetime trigger pulses to the switch trigger pins. The trigger generator derives its bias from the MARX charge system itself, eliminating the need for an external power source and greatly reducing generator size. In addition, the trigger generator can be triggered by means of a plastic fiber optic cable making it possible to place the generator in near proximity of each capacitor switch electrode, increasing response time.

FIG. 20 is a schematic illustration of a switch protection feature in accord with all example embodiment of the present invention. A set of MOV devices 201 can be constructed on a support structure which, when connected across the switch assembly 202 as shown in the figure, can prevent over voltage conditions in the event of late switch firing. The MOV system can be designed so that it draws little current when in a normal mode but draws large current in a fault condition thus preventing large over-voltage conditions. In addition, the MOV system can be used to provide biasing for the trigger generator.

Inductor System.

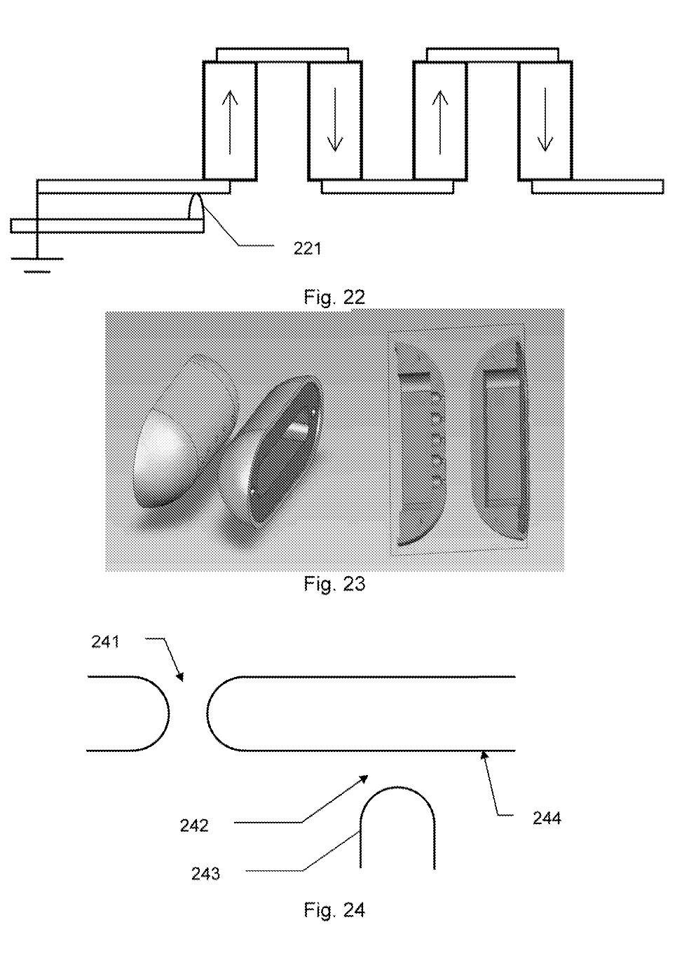

FIG. 21 is a schematic illustration of an inductor system suitable for use with the present invention. The inductor can comprise two spiral conductors, which each provide a self-inductance. The separation between the two spirals provides a mutual inductance that can be adjusted by adjusting the spacing between the two spirals to yield to the desired final inductance (avoiding sliding contacts or other problematic adjustment methods). Those skilled in the art will appreciate other variable inductor structures that can provide appropriate inductance for the desired system performance.

Surge Arrestor Apparatus.

The present invention can comprise a surge suppressor apparatus, including a plurality or surge arrestor elements. Metal oxide varistors (MOVs) can be suitable as surge arrestor elements. Each surge arrestor element has two terminals, and allows current flow through the element between the first and second terminals. The surge arrestor elements are arranged in an electrical series circuit, and are mounted so that current in one surge arrestor element is in a direction substantially opposite the direction of current in an adjacent surge arrestor element. The opposite direction current flow can reduce the inductance of the surge suppressor apparatus and can aid in shielding the apparatus.

Embodiments of the invention further mount the surge arrestor elements such that each surge arrestor element mounts adjacent to a surge arrestor element having current flow in a direction substantially opposite the direction of current flow in the surge arrestor element. The surge arrestor elements can be configured such that current flow in each surge arrestor element defines an axis, and mounted relative to each other such that the axes are substantially parallel. Connecting the terminals of adjacent surge arrestor elements to produce an electrical series circuit can then have current in each surge arrestor element substantially opposite current in an adjacent surge arrestor element, reducing the inductance of the apparatus and aiding in shielding the elements. Embodiments of the present invention can mount the surge arrestor elements such that their axes intersect a single straight line or a curve in two dimensions. Terminals of the surge arrestor elements can be electrically connected with metallic elements, for example with metallic elements pressed against the terminals.

The present invention also comprises a system for producing a shaped electrical waveform using a surge suppressor apparatus as described above. The system comprises an electrostatic energy storage system, capable of storing electrical energy and producing a potential above a ground or reference potential. The system further comprises an inductor, placed in electrical communication with the electrostatic energy storage system. A second terminal of the inductor is placed in electrical communication with the surge suppressor apparatus, and with a load or output terminal of the system.

The electrostatic energy storage system can comprise a plurality of capacitors mounted relative to each other, as in a conventional Marx generator. The surge arrestor elements can be mounted relative to the capacitors such that capacitors charged to high voltages mount proximal surge arrestor elements that experience high voltages in operation. Such placement can aid in shielding the system.

The present invention can also provide a surge suppressor system comprising a surge arrestor element mounted with a return conductor. The return conductor can be configured so that current flow through the surge arrestor element is balanced by current in the return conductor. As an example, a return conductor can be mounted with a surge arrestor element such that the return conductor connects to the surge arrestor element at one end thereof, and extends toward the other end of the surge arrestor element, effectively surrounding the surge arrestor element in directions perpendicular to the direction of current flow through the surge arrestor element. The return conductor can physically surround the surge arrestor element, such as when a cylindrical surge arrestor element is mounted within and coaxial with a larger diameter return conductor. The return conductor can also effectively surround the surge arrestor element by providing periodic conductors, such as a plurality of conductive bars or rods extending from the connected end of the surge arrestor element toward the other end of the surge arrestor element.

The return conductor can be spaced apart from the surge arrestor element by a first distance near the connected end, and by a greater distance near the other end. The voltage difference between the surge arrestor element and the return conductor can be lowest at the connected end, and the greatest at the other end. Separation by a larger distance at the unconnected end can provide desirable electrical isolation where the potential difference is greatest.

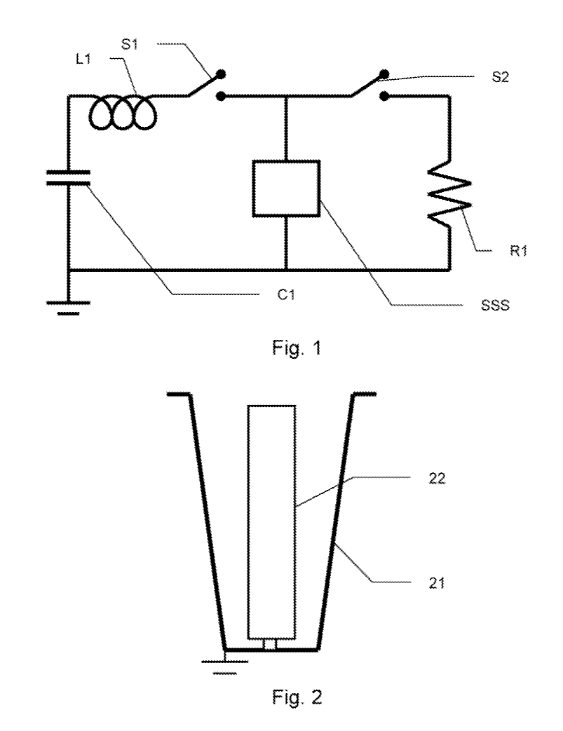

FIG. 1 is a schematic illustration of an example circuit for a pulsed power system incorporating a surge suppressor according to the present invention. An energy source C1 (often a capacitor or multi-capacitor system) connects with an inductive system (represented by inductor L1 in the figure). A switch S1 allows the energy source to be selectively connected to a load resistor. A second switch S2 allows the energy source to be first connected to a surge suppression system SSS then to the load resistor R1. The energy source, surge suppression system and load resistor can be connected to a common reference voltage (e.g., ground). A suitable surge suppression system can comprise a metal oxide varistor. For some high voltage applications, however, a suitable metal oxide varistor can exceed 1 meter in length. The associated inductance can severely limit performance of the system if significant current is required.

Some pulsed power applications require surge suppressor systems to operate at about 500 kV. carrying 20 kA, with rise times of less than 30 nS. This can indicate that the total inductance of the surge suppressor system should be less than 1 uH. In contrast, other applications of surge suppression systems (e.g., lightning protection) can accommodate rise times of 8 uS, and so inductance is a lesser concern.

FIG. 2 is a schematic illustration of a surge suppressor system with a return conductor, a configuration that can provide surge suppression with the desired inductance. A surge arrestor element 22, e.g., a metal oxide varistor or a stack of metal oxide varistors, can be mounted within a return conductor 21. The return conductor 21 can be spaced farther from the surge arrestor element at the high voltage end than at the low voltage end, providing adequate electrical isolation. The return conductor can be connected to the reference voltage (e.g., ground).

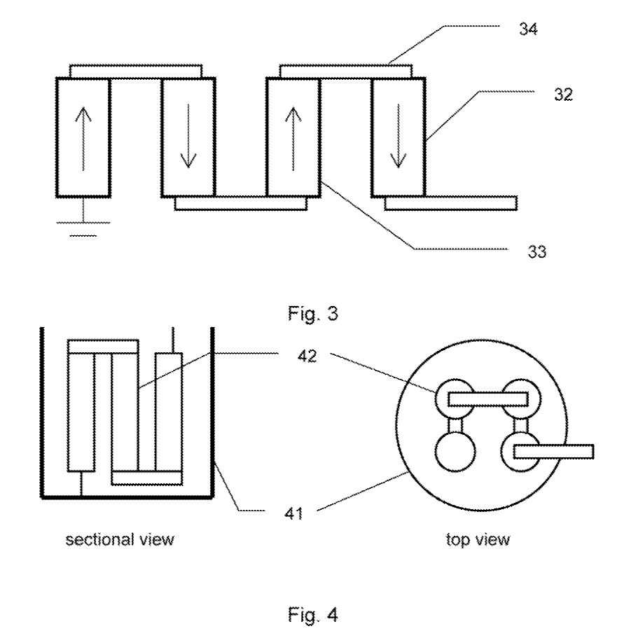

FIG. 3 is a schematic illustration of a surge suppressor system having a plurality of surge arrestor elements in a series circuit and arranged such that current flows in opposite directions in adjacent surge arrestor elements (e.g., 32, 33). The total length of surge arrestor element required can be divided into a plurality of individual surge arrestor elements. The surge arrestor elements can be connected (e.g., with connector such as 34) in a series electrical circuit, and mounted such that current in adjacent surge arrestor elements flows in substantially opposite directions. The net magnetic field is thereby reduced, and consequently the effective inductance is also reduced. While FIG. 3 shows the surge arrestor elements disposed along a line for ease of illustration, they can be configured along a curve in two dimensions, or in various other arrangements that maintain the opposing direction current characteristic. FIG. 4 is a schematic illustration of a surge suppressor apparatus similar to that on FIG. 3, with the surge arrestor elements (e.g., 42) configured along a curve, and mounted within a conducting container 41. The container is depicted with a circular cross section for ease of illustration, but can in general have any appropriate shape. The addition of the conducting container can further reduce the inductance of the surge suppression system.

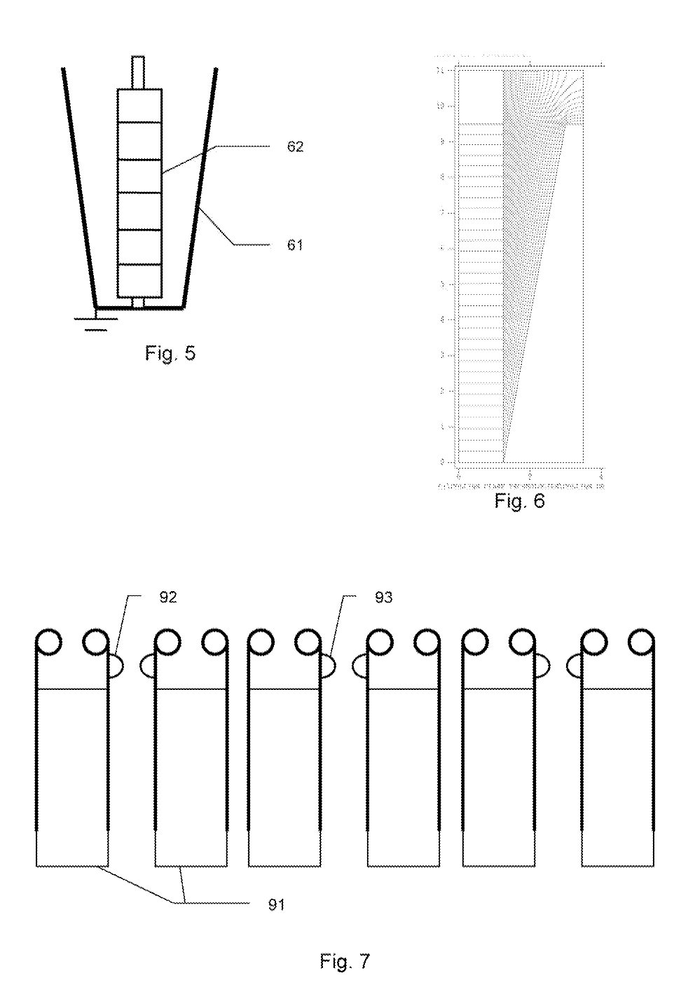

FIG. 5 is a schematic illustration of an example circuit for a pulsed power system incorporating a surge suppressor according to the present invention. It is similar in operation to the circuit shown in FIG. 1. As discussed before, the stray inductance in the surge suppression portion of the circuit can limit performance for some applications. As a specific example, low voltage, low current applications, addressed with relatively small numbers of metal oxide varistors (e.g., 50 kv, 5 ka, 50 disks) can achieve adequate performance without special regard to inductance of the surge suppression system. Inductance can have a significant detrimental effect on performance in higher power applications (e.g., 500 kv, 50 ka, 50 disks).

FIG. 6 is a schematic illustration of a surge suppressor system having a plurality of surge arrestor elements disposed within and coaxial with a return conductor, a configuration that can provide desired surge suppression with acceptably low inductance. A stack of metal oxide varistors 62, e.g., 5 to 10 disks capable of 50-100 kV each, provides a surge arrestor element. The surge arrestor element can be mounted with a return conductor 61 that effectively surrounds the surge arrestor element in directions perpendicular to the direction of current flow through the surge arrestor element, in the figure, the stack is mounted with a coaxial, conical conducting container that can be designed to withstand the required electric fields. Current flows into the stack at the top (in the figure) and exits at the bottom (in the figure). Because the bottom of the stack is in electrical contact with the container, the current flows back up the container and exits at the rim. Because equal and opposite currents flow in the metal oxide varistor stack 62 and the container 61, substantially all magnetic field energy is trapped between the two and does not extend past the container, inductance is thus greatly reduced from that of an unshielded stack.

Managing electrostatic breakdown between the stack and the container can be an important design consideration. The trapezoid sectional shape, close to the stack at the bottom and further away at the rim, can further reduce inductance while still allowing adequate breakdown protection.

FIG. 7 is a graph of two dimensional electrostatic simulation results for the system depicted in FIG. 6. Well known empirical design criterion dictate the maximum electric field (hence the minimum distance between metal oxide varistor stack and container wall). Since the stack voltage is greatest at the rim, the gap there must generally be the largest. In practice, the system can include an insulating baffle at the output so that the stack can be immersed in an insulating medium, such as transformer oil or sulfur hexafloride gas. Also, the stack can be secured by, for example, welding the disks together or using a pressure clamp.

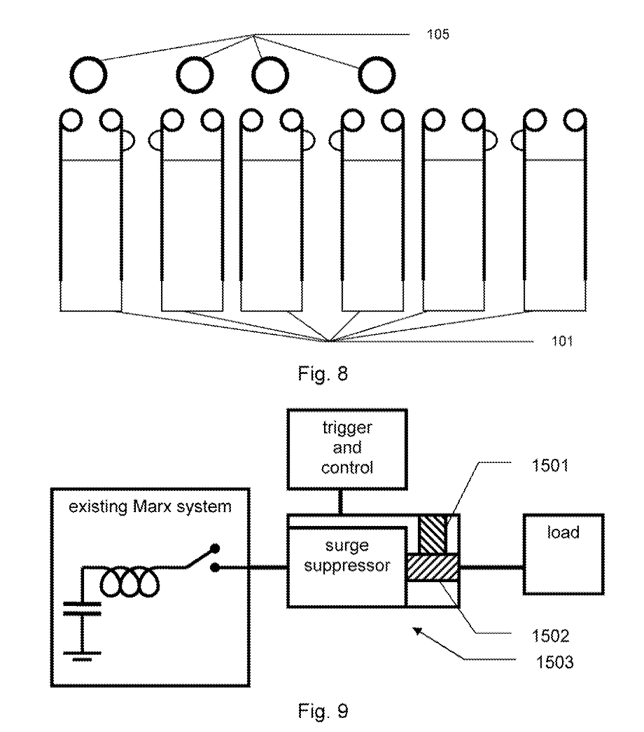

FIG. 8 is a schematic illustration of an example circuit for a pulsed power system incorporating a surge suppressor according to the present invention. In operation, the capacitor C1 is initially charged to a constant voltage. When switch S1 is closed, current flows through inductor L1 and through the surge suppressor system SSS (as long as the voltage exceeds the surge suppressor system clamp voltage). This can result in a substantially constant voltage pulse across the surge suppressor system while the current through the surge suppressor system is a strong function of time. At the proper time in the discharge, switch S2 can be closed, connecting the load resistor R1 and transferring surge suppressor system current to the load resistor R1.

In many applications, the rise-time and pulse-width of the voltage across the load resistor can be important parameters. In prior art systems, these two parameters were set by the design of the system and were difficult or impossible to alter without fundamental changes in design.

The present invention can comprise a simple technique, unique to the surge suppressor system, in which both of these parameters can be easily adjusted. Because of the non-linear nature of the surge suppressor system (e.g., one incorporating metal oxide varistors), the rise-time into the load resistor is a strong function of the time at which switch S2 is closed. When fired at T=0, i.e. simultaneously with closing of S1, the rise-time is relatively stow. As the time delay between S1 closing and S2 closing increases, the rise-time is decreased, reaching a minimum value related to stray circuit inductances associated with the load. The pulse-width is a strong function of the value of inductor L1. As its value is increased, the effective pulse-width is increased. An example embodiment can employ a mechanical shorting rod to eliminate or include turns on the inductor and provide the necessary adjustments. The adjustments to switch timing and inductance are only mildly dependent on each other, allowing a simple computer controlled system to set both rise-time and pulse-width.

FIG. 7 is a schematic illustration of a Marx generator having switches according to the present invention. A simple method of generating high voltage pulses, the Marx generator employs a set of capacitors (e.g., capacitors 91) that are charged in parallel to the same voltage, typically 50 kv-100 kv. Once the capacitors are fully charged, the switches 92, 93 are fired connecting the chain in series. Just as with batteries connected in series, the voltages add to produce the required output pulse (6× the charge voltage in the system of FIG. 7).

The switches can be important components in the performance of a Marx system. They must not only hold the charge voltage, they must also be triggered to close simultaneously in order to produce the required output. Triggering of these switches can be accomplished in several ways. One conventional method is a high voltage, very fast electrical pulse applied to a trigger electrode in each switch. While quite effective, the required hardware and voltages make this scheme awkward, large and unreliable. Another conventional method to trigger the Marx switches is through the use of lasers. An example of this method uses a simple Nitrogen laser operating in the ultraviolet part of the spectra. The hardware is simple, requiring only optical components (tenses, fiber optics etc) and thus quite compact. A significant problem with this technique is that it wilt only work for a sufficiently fast charge rate for the Marx capacitors. This time dependence on capacitor voltage severely restricts its use.

The present invention can comprise a new technique in which the electrical and laser triggering schemes are combined. An electrical trigger 92 is applied only to the first switch in the chain, the one closest to ground. All other stages utilize the laser technique, e.g. switch 93 in the figure. After the Marx capacitors are fully charged, the electrical trigger 92 at stage one is fired. When this switch closes, a fast rising voltage pulse is coupled forward to the other stages, This fast rising voltage now provides the required time dependence to allow the laser triggering to be used. The use of this combined technique eliminates the majority of hardware and complexity associated with electrical triggering and enables the simple technique of laser triggering. This method can be optimized by integrating the switches into the capacitor grading structure as seen in FIG. 7. The switch electrodes can be hollow and can be aligned so that a single laser located at the ground end of the Marx can pass a beam through the entire set of switches.

One issue that can affect the performance of a pulsed power system using a surge suppression system according to the present invention is the inductance associated with current flowing in the surge suppression system. The surge suppression systems previously described can provide a basis for a solution. Since the surge arrestor elements are generally limited to relatively low voltage (50-100 kv), a plurality of them must be connected in series for high voltage (˜>500 kv) applications. They can be arranged in as tight a package as possible to minimize the stray inductances between the modules. This can be complicated by the fact that each subsequent surge arrestor element is charged to a higher voltage than the previous one. Too close a spacing can result in electrical breakdown (arcing) between the surge arrestor elements or to ground.

FIG. 8 is a schematic illustration of a Marx generator having switches and a surge suppressor system according to the present invention. Surge arrestor elements 105 are disposed in relation to the Marx generator, such that each surge arrestor element mounts proximal a Marx stage 101 with a similar operating voltage. This optimization is possible because each stage of the Marx generator adds to the voltage of the previous stage in a similar manner as the voltage change across the plurality of surge arrestor elements. In FIG. 8 a six stage Marx is shown along with four surge arrestor elements.

For illustration assume that each stage is initially charged to 100 kv, resulting in a 600 kv total “erected” voltage after Marx switches are fired. At that point, for instance the third stage would have a 300 kv potential relative to ground. If the surge arrestor elements are designed to have the same 100 kv potential when current flows, each one can be arranged next to a Marx stage with the same potential. In this way the Marx stages and the surge arrestor elements help shield one another, reducing the total inductance. This is a packaging scheme for an integrated system, where the Marx system and the surge suppression system are designed together as a single system. For applications where a surge suppression system is to be added to an existing Marx system, alternate packaging can be desirable and is described elsewhere herein.

In some applications, an existing pulsed power circuit can benefit from the incorporation of the present invention, but redesign or rebuilding the existing system to accommodate features as discussed elsewhere herein can be prohibitive in cost or time. A surge suppression system according to the present invention can be retrofitted onto such existing pulsed power systems, As shown in FIG. 9, an existing pulsed power system can be viewed as incorporating an energy source and an inductor. A surge suppression system 1503 can be added to such an existing system, for example as a complete package including all hardware and control devices (e.g., an output switch 1502 and a crowbar switch 1501) to allow independent operation of the surge suppressor system 1503 in connection with the existing pulsed power system.

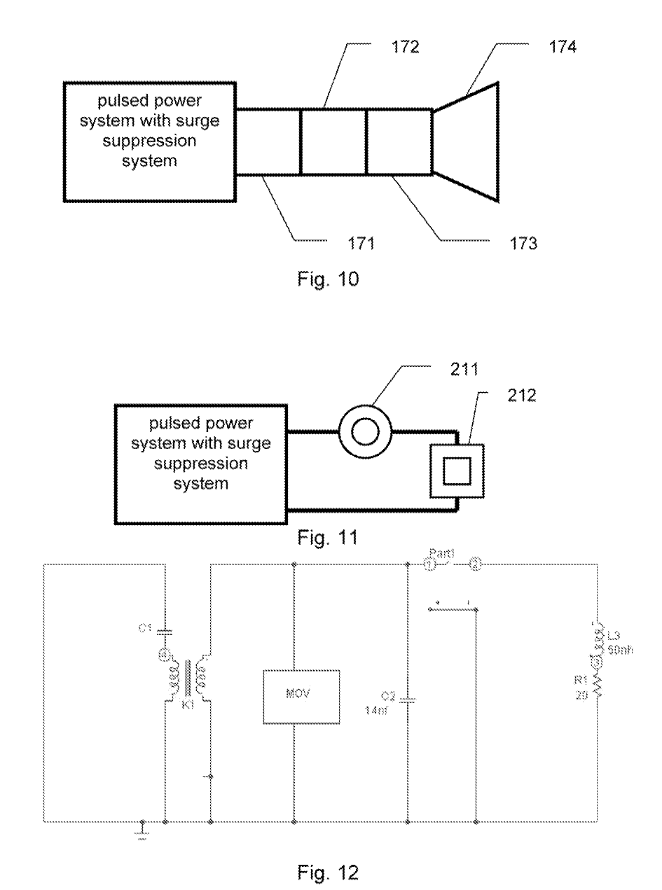

The present invention can comprise a system such as that in FIG. 10 comprising a surge suppression system and pulsed power circuit as described before, as applied to driving an “active” high power microwave load (e.g., an electron beam generation section 171, a microwave generation section 172, a mode conversion section 173, and an antenna section 174). There are a number of specific high power microwave tubes in existence. They generally operate in the 100 kV-10000 kV and require pulsed power risetimes of less than about 100 nS. The tubes differ in their operating impedance ranges. Examples of such tubes include Split Cavity Oscillator (SCO): 200 kV, 200 ohms, >10 MegaWatts radiated-; Relatron:600 kV, 1000 Ohms, 100 MegaWatts radiated, Relativistic, Magnetron (RELMAG): 500 kV, 40 Ohm, >100 MegaWatts radiated: Virtual Cathode Oscillator (VIRCATOR): 500 kV, 20 Ohm, >500 MegaWatts radiated; Relativistic Klystron Oscillator (RKO): 500 kV, 20 Ohm, >500 MegaWatts radiated; Magnetic insulated Line Oscillator (MILO): 500 kV, 8 Ohm, >500 MegaWatts radiated.

Each of these tubes presents a unique, dynamic load and thus unique pulsed power requirements. A pulsed power system including a surge suppression system according to the present invention can be designed to drive each of these tubes and thus other tubes in the same range. The ability to drive dynamic loads of impedance ranging from <10 Ohms to >100 Ohms represents a capability that is not possible with any single prior art pulsed power system.

A pulsed power system according to the present invention can be applied as shown in FIG. 11, using either the inductive circuit or the resistive circuit. In the application illustrated, an external device under test can be connected across output terminals of the system. As examples, such a device can be either a voltage probe 212 or a current probe 211 needing calibration. A very fast rise (<10 nS), long (>1 uS), very flat pulse (˜+/−2%) pulse is provided. Calibrated probes internal to the system can provide reference signals. The combination of fast rise with long pulse allows calibration of the probes over a broad frequency range at high power in a single device. In this way all non-linearity in the probe response can be ascertained with a single device.

The present invention can also be suitable for use with transformer-based pulsed power systems, such as that depicted schematically in FIG. 12. With a transformer-based system, the initial energy store can be in a capacitor located in the primary circuit at relatively low voltage. Discharge through the primary circuit can couple energy into the secondary circuit with a resulting voltage increase given by the transformer turns ratio. For certain applications, the ability to store energy at low voltage outweighs the disadvantage of storing the energy twice, first in the primary and then in the secondary capacitor. The present invention can comprise a surge suppressor system (such as a metal oxide varistor element or elements) to provide voltage shaping without the need for any pulse forming element. In operation, capacitor C1 discharges through the primary of transformer K1 producing a voltage on capacitor C2 and the surge suppression system. With proper choice of parameters, the surge suppression system can clamp the voltage across capacitor C2. At the appropriate time, switch PART 1 can be closed connecting the load resistor R1. Typical resulting waveforms are shown in FIG. 13. Note that the load voltage has a steep risetime and a long period of substantially constant voltage.

Materials and Methods.

Surge arrestors are commercial off the shelf (COTS) products utilized in numerous commercial and consumer products to protect sensitive electronic devices from electrical transients such as lightning strikes. Examples range from industrial facility protection to personal computer surge protection power strips. For use in the current invention, several COTS components are readily available. The General Electric model 9L26ZNW3228S FB-02 D and the Panasonic model ZNR20182 have been used in example implementations of this invention.

### EXAMPLE EMBODIMENT

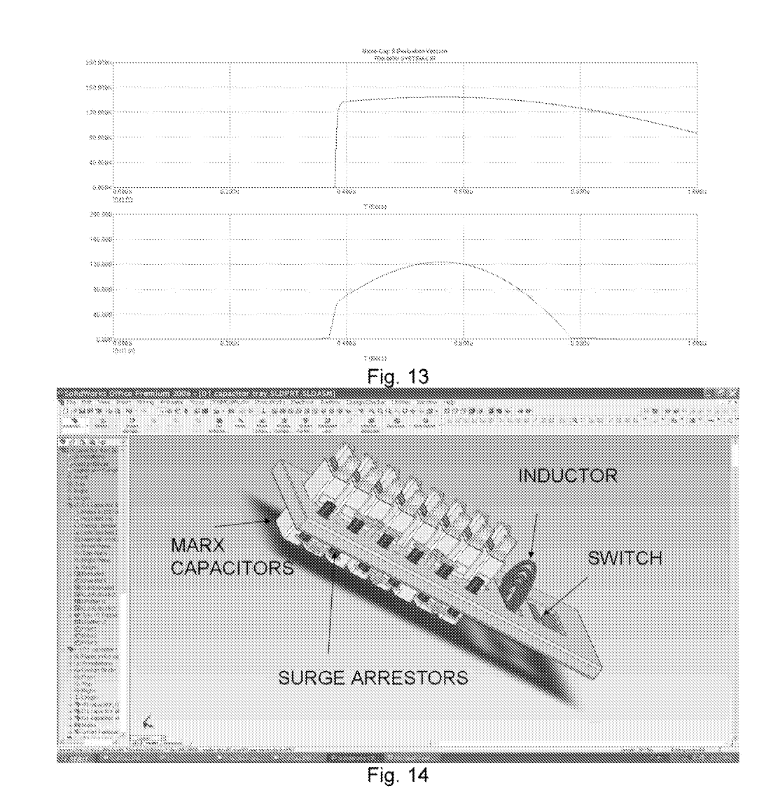

A specific implementation of the present invention is shown in FIG. 14. The various components are identified and are the physical embodiments of the components in the circuit diagram in FIG. 1. All components are mounted in a dielectric plate 20″×30″×2 thick and are assembled and installed with conventional pulsed power techniques and tools. Non-COTS components such as capacitor mounting hardware, inductor hardware, Marx switch hardware and output switch hardware are fabricated with conventional manufacturing techniques. This hardware is designed to drive a high power microwave load at 500 kilovolts, 10 kiloamperes, 200 nanoseconds. Those skilled in the art will appreciate several peripheral yet important components such as charge resistors, trigger components and high pressure containment vessel, not shown in the diagram but common to pulsed power systems.

The surge arrestor can also be made to provide step-wise voltage adjustment with an embodiment such as that illustrated schematically in FIG. 22. A sliding (or otherwise selectable) ground connection 221 can provide selective coupling of MOV modules to ground, allowing step-wise adjustment in the characteristics of the surge arrestor.

Output Switch.

FIG. 23 is a schematic illustration of an output switch in accord with an example embodiment of the present invention. The switch comprises two cylindrical electrodes mounted near but not in physical contact with each other. At least one of the electrodes has openings through it, with pins mounted in the openings. Switch triggers, like those discussed previously, can be used to selectively trigger the output switch with highly accurate timing. Those skilled in the art will appreciate other output switch structures that can provide output switch capability suitable for some applications.

Crowbar Switch.

An example embodiment of such a crowbar switch is illustrated schematically in FIG. 24. The output of the pulse system can be coupled to a load via a conductor 244 across an output switch gap 241. A conductive path 243 to ground or to a ballast resistor or other load can be provided across a crowbar switch gap 242. The crowbar switch can comprise cylindrical electrodes and switch triggers like those discussed in connection with the output switch. Those skilled in the art wilt appreciate other crowbar switch structures that can provide crowbar switch capability suitable for some applications.

Static Test Load.

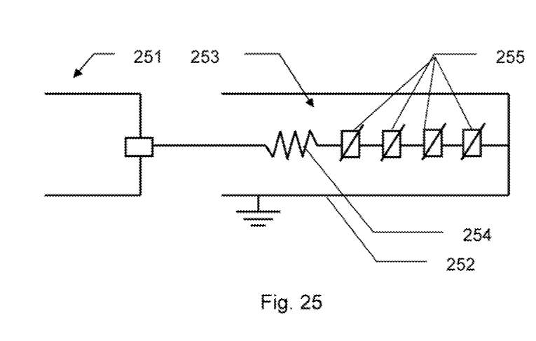

Some embodiments of the present invention allow selective coupling to a static test load. Such a static test toad can allow testing of the system without exposing actual loads to risk of damage or consumption. As illustrated schematically in FIG. 25, a pulse system 251 such as those described herein can be coupled to a load comprising a resistor 254 and an appropriate configuration of MOV elements 255 then to a reference such as ground through a path such as a coaxial conductor 252. The resistor 254 and MOV elements 355 can be separated from the coaxial conductor 252 with, as examples, gas, liquid, or solid insulation. The MOV elements can provide high power capability in less space than previous approaches. The static test road can be connected to or isolated from the pulse system by configuring physical connections or by controlling appropriate switches.

The particular sizes and equipment discussed above are cited merely to illustrate particular embodiments of the invention. It is contemplated that the use of the invention may involve components having different sizes and characteristics. It is intended that the scope of the invention be defined by the claims appended hereto.

What is claimed is:

1) A pulsed power system comprising:
a) A MARX system;
b) An inductor system in electrical communication with the MARX system;
c) A surge arrestor system in electrical communication with the inductor system;
d) An output switch system in electrical communication with the surge arrestor system;
e) A crowbar switch system in electrical communication with the output switch system.

2) A pulsed power system as in claim 1, further comprising a static test load selectively placed in electrical communication with the crowbar switch system.

3) A pulsed power system as in claim 1, wherein the surge arrestor system comprises a plurality of surge arrestor elements, each having first and second terminals, and disposed in series, wherein:
a) the first surge arrestor element in the series has a first terminal adapted to be placed in electrical communication with the inductor system;
b) the last surge arrestor element in the series has a second terminal adapted to be placed in electrical communication with the output switch system;
c) each surge arrestor element in the series other than the last has a second terminal in electrical communication with the first terminal of the next surge arrestor element in the series; and
d) the surge arrestor elements are mounted relative to each other such that electrical current in one surge arrestor element is in a direction substantially opposite electrical current in an adjacent surge arrestor element.

4) A pulsed power system as in claim 1 wherein the surge arrestor system comprises:
a) A surge arrestor element having first and second ends between which current flows in operation;
b) A return conductor in electrical communication with the surge arrestor element proximal the first end thereof, and configured such that the return conductor effectively surrounds the surge arrestor element in directions perpendicular to the direction of current flow through the surge arrestor element in operation.

5) A system as in claim 4, wherein the return conductor is spaced apart from the surge arrestor element by a first distance near the first end of the surge arrestor element, and by a second distance, greater than the first distance, near the second end of the surge arrestor element.

6) A system as in claim 4, wherein the return conductor comprises a substantially solid surface surrounding the surge arrestor element in directions perpendicular to the direction of current flow through the surge arrestor element in operation.

7) A system as in claim 4, wherein the return conductor comprises a plurality of conductive elements disposed about the surge arrestor element such that each conductive element is separated from the surge arrestor element by respective first distance near the first end of the surge arrestor element and by a respective second distance, greater than the first distance, near the second end of the surge arrestor element.

8) An apparatus as in claim 1, wherein the surge arrestor system comprises a plurality of metal oxide varistor elements.

9) A system for producing a shaped electrical waveform, comprising:
a) An electrostatic energy storage system, having a reference terminal adapted to be placed in electrical communication with a reference potential, and having an output terminal;
b) An inductor, having an input terminal in electrical communication with the output terminal of the electrostatic energy storage system, and having an output terminal;
c) A surge arrestor apparatus having first and second terminals, wherein the first terminal of the surge arrestor apparatus is in electrical communication with the output terminal of the inductor, and wherein the second terminal of the surge arrestor apparatus is adapted to be placed in electrical communication with the reference potential;
d) An output switch, having input and output terminals, wherein the input terminal is in electrical communication with the output terminal of the inductor, wherein the output switch selectively places its input and output terminals in electrical communication, and wherein the output terminal is adapted to be placed in electrical communication with a load;
e) A crowbar switch, having input and output terminals, wherein the input terminal is in electrical communication with either the input or output terminal of the output switch, and wherein the output terminal is in electrical communication with the reference potential, and wherein the crowbar switch selectively places its input and output terminals in electrical communication.

10) A system as in claim 9, further comprising a static test load, adapted to be selectively placed in electrical communication with the output terminal of the output switch or in electrical isolation from the output terminal of the output switch.

11) A system as in claim 9, wherein the electrostatic energy storage system comprises
a) A support structure;
b) A plurality of capacitors, each having nonconductive mounting features adapted to allow secure and removable mounting with the support structure.

12) A system as in claim 9, wherein the electrostatic energy storage system comprises
a) A plurality of MARX capacitors;
b) A plurality of switch electrodes, each mounted with a MARX capacitor such that electrical communication between the MARX capacitors can be accomplished through the switch electrodes;
c) A plurality of trigger generators. each mounted with a switch electrode; wherein each trigger generator comprises a plurality of switch/capacitor elements connected in series, wherein each switch/capacitor element comprises a solid state switch and a capacitor connected in parallel.

13) A system as in claim 9, wherein the electrostatic energy storage system comprises
a) A plurality of capacitors, mounted such that they can be connected via switches;
b) A fault protection element mounted between the terminals of a switch, comprising a plurality of metal oxide varistors.

14) A system as in claim 9, further comprising a voltage selector element comprising a plurality of metal oxide varistors disposed in electrical series between a first terminal and a second terminal, and wherein the first terminal is in electrical communication with the output terminal of the output switch, and wherein the second terminal is in electrical communication with the reference potential, and having a third terminal in electrical communication with an intermediate point in the series-connected metal oxide varistors.

15) A system as in claim 9, wherein the surge arrestor apparatus comprises a plurality of surge arrestor elements, each having first and second terminals, and disposed in series, wherein:
a) the first surge arrestor element in the series has a first terminal adapted to be placed in electrical communication with the output terminal of the inductor;
b) the last surge arrestor element in the series has a second terminal adapted to be placed in electrical communication with the reference potential;
c) each surge arrestor element in the series other than the last has a second terminal in electrical communication with the first terminal of the next surge arrestor element in the series; and
d) the surge arrestor elements are mounted relative to each other such that electrical current in one surge arrestor element is in a direction substantially opposite electrical current in an adjacent surge arrestor element.

16) A system as in claim 9, wherein the surge arrestor apparatus comprises a plurality of surge arrestor elements, each having first and second terminals, and disposed in series, wherein:
a) the first surge arrestor element in the series has a first terminal adapted to be placed in electrical communication with the output terminal of the inductor;
b) each surge arrestor element in the series other than the last has a second terminal in electrical communication with the first terminal of the next surge arrestor element in the series;
c) an external circuit terminal, mounted with the surge arrestor element such that the terminal can be placed selectively in electrical communication with the second terminal of any of several of the plurality of surge arrestor elements.

17) A pulsed power system as in claim 9, wherein the surge arrestor apparatus comprises:
a) A surge arrestor element having first and second ends between which current flows in operation;
b) A return conductor in electrical communication with the surge arrestor element proximal the first end thereof, and configured such that the return conductor effectively surrounds the surge arrestor element in directions perpendicular to the direction of current flow through the surge arrestor element in operation,

18) A system as in claim 17, wherein the return conductor is spaced apart from the surge arrestor element by a first distance near the first end of the surge arrestor element, and by a second distance, greater than the first distance, near the second end of the surge arrestor element.

19) A system as in claim 17, wherein the return conductor comprises a substantially solid surface surrounding the surge arrestor element in directions perpendicular to the direction of current flow through the surge arrestor element in operation.

20) A system as in claim 17, wherein the return conductor comprises a plurality of conductive elements disposed about the surge arrestor element such that each conductive element is separated from the surge arrestor element by respective first distance near the first end of the surge arrestor element and by a respective second distance, greater than the first distance, near the second end of the surge arrestor element.

21) An apparatus as in claim 17, wherein the surge arrestor system comprises a plurality of metal oxide varistor elements.

22) A system as in claim 9, wherein the output switch system comprises first and second electrodes, and a trigger generator, mounted with the first electrode, wherein the trigger generator comprises a plurality of switch/capacitor elements connected in series, wherein each switch/capacitor element comprises a solid state switch and a capacitor connected in parallel.

23) A system as in claim 9, wherein the crowbar switch system comprises first and second electrodes, and a trigger generator, mounted with the first electrode; wherein the trigger generator comprises a plurality of switch/capacitor elements connected in series, wherein each switch/capacitor element comprises a solid state switch and a capacitor connected in parallel.

24) A system as in claim 10, wherein the static load system comprises a plurality of metal oxide varistors connected in an electrical series and placed in electrical communication with the output terminal of the output switch and with the reference potential.

25) A pulsed power apparatus, comprising a plurality of pulsed power systems as in claim 1.

26) A pulsed power apparatus, comprising a plurality of pulsed power systems as in claim 9.

27) A pulsed power system as in claim 1, wherein the inductor system comprises first and second spiral conductors mounted in proximity to each other.

28) A pulsed power system as in claim 9, wherein the inductor comprises first and second spiral conductors mounted in proximity to each other.
